(19) United States
(12) Patent Application Publication
(10) Pub. No.: US 2010/0238573 A1
(43) Pub. Date: Sep. 23, 2010

(54) Light-collection apparatus

(75) Inventor: Chih-Hung Wu, Longtan Shiang (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/980,772

(22) Filed: Oct. 31, 2007

(51) Int. Cl. G02B 5/10; G02B 5/00

(52) U.S. Cl. 359/868; 359/896

(57) ABSTRACT

A light-collection apparatus includes a core, a first layer and a second layer. The core is made in the form of a frustum and used as a solid light-passing zone. The first layer is provided on the core. The second layer is provided on the first layer. Therefore, the light-collection apparatus is excellent in collecting light, easily mass-produced at a low cost, durable and environmentally friendly.

### BACKGROUND OF INVENTION

1. Field of Invention

The present invention relates to a light-collection apparatus and, more particularly, to a light-collection apparatus that is excellent for collecting light, easily mass-produced at a low cost, durable and environmentally friendly.

2. Related Prior Art

A conventional light-collection apparatus includes a block of metal with a high reflectivity. In use, a lens is provided on a side of the light-collection apparatus at a proper distance while a solar cell or a photo-sensor is provided on another side of the light-collection apparatus at another proper distance. Light comes from a light source and reaches the lens. The lens converges the light. The light-collection apparatus further converges, collects and transfers the light to the solar cell or photo-sensor. Hence, the performance of the solar cell or photo-sensor is enhanced.

The conventional light-collection apparatus is not without drawbacks although it is able to collect the light to enhance the performance of the solar cell or photo-sensor. The conventional light-collection apparatus must include a block of metal with a high reflectivity to enhance the reflection of the light. To further enhance the reflection of the light, a film with a high reflectivity is provided on the block. The film can be provided on the block by coating. Alternatively, a plate is cut into a proper shape, the film is provided on the plate by coating, and the plate coated with the film is attached to the block by gluing. The process of coating and/or the process of gluing are complicated and expensive so that the light-collection apparatus cannot be made on an economic scale.

The present invention is therefore intended to obviate or at least alleviate the problems encountered in prior art.

### SUMMARY OF INVENTION

The primary objective of the present invention to provide a light-collection apparatus that is excellent in collecting light, easily mass-produced at a low cost, durable and environmentally friendly.

To fulfill the primary objective of the present invention, the light-collection apparatus includes a core, a first layer and a second layer. The core is made in the form of a frustum and used as a solid light-passing zone. The first layer is provided on the core. The second layer is provided on the first layer.

Other objectives, advantages and features of the present invention will become apparent from the following description referring to the attached drawings.

### BRIEF DESCRIPTION OF DRAWINGS

The present invention will be described via detailed illustration of two embodiments referring to the drawings wherein:

FIG. 1 is a perspective view of a light-collection apparatus according to the first embodiment of the present invention;

FIG. 2 is a cross-sectional view of the light-collection apparatus shown in FIG. 1;

FIG. 3 is a cross-sectional view of a lens, a light-receiving element and the light-collection apparatus shown in FIG. 2; and

FIG. 4 is a cross-sectional view of a light-collection apparatus according to the second embodiment of the present invention

### DETAILED DESCRIPTION OF EMBODIMENTS

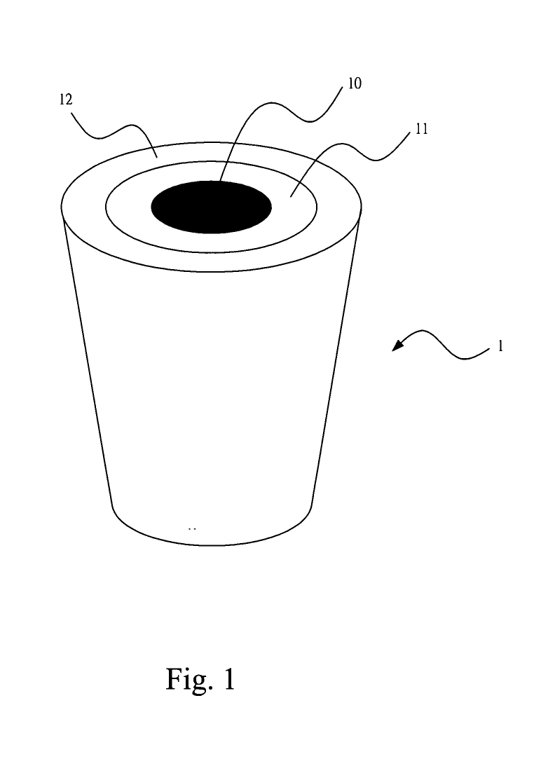

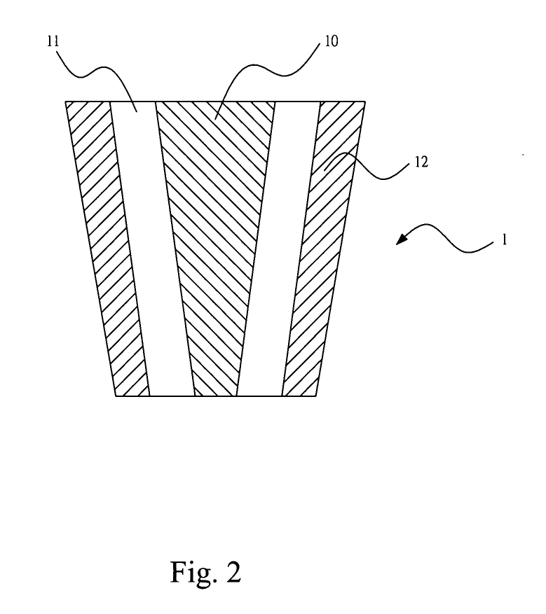

Referring to FIGS. 1 and 2, a light-collection apparatus 1 includes a core 10, a first layer 11 and a second layer 12 according to a first embodiment of the present invention. The light-collection apparatus 1 is therefore excellent in collecting light, easily mass-produced at a low cost, durable and environmentally friendly.

The core 10 is a tapered frustum used as a light-passing zone. The core 10 is made of a light-weighted transparent material such as polymethylmethacrylate, acrylic, glass, plastic and quartz. To satisfy on different needs, the core 10 can be a circular frustum or a polygonal frustum. The core 10 is preferably a circular frustum as shown in the drawings.

The first layer 11 is provided on and around the core 10. The first layer 11 is made of a metallic adhesive material with a high refraction index. The metallic adhesive material may be silver glue for example.

The second layer 12 is provided on and around the first layer 11. The second layer 12 is made of a light-weight transparent material such as polymethylmethacrylate, acrylic, glass, plastic and quartz. Therefore, a novel light-collection apparatus is provided.

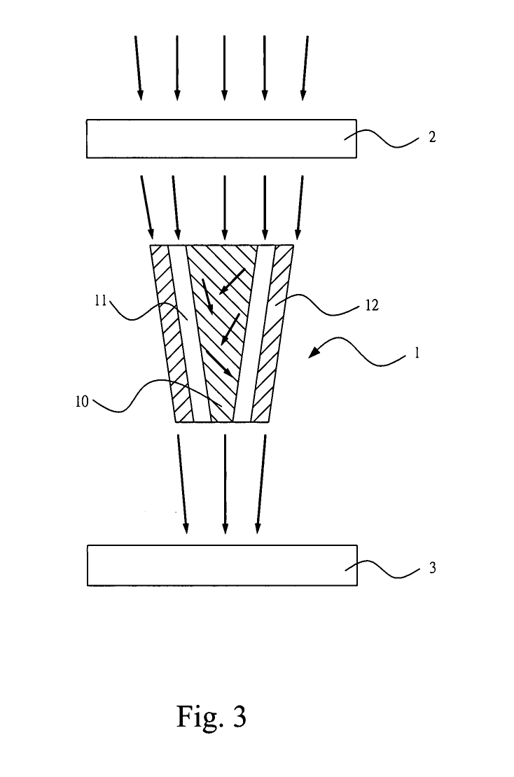

Referring to FIG. 3, in use, a lens 2 is provided on a side of the light-collection apparatus 1 at a proper distance while a light-receiving element 3 is disposed on another side of the light-collection apparatus 1 at another proper distance. The light-receiving element 3 may be a solar cell or a photo-sensor. Light comes from a light source and reaches the lens 2 substantially parallel to the axis of the lens 2. The lens 2 slightly converges the light. Hereinafter, some of the light reaches the core 10 substantially parallel to the axis of the core 10 while the other of the light reaches the core 10 not parallel to the axis of the core 10. Because of the properties of the first and second layers 11 and 12, the light-collection apparatus 1 refracts, collects and transfers the light to the light-receiving element 3. The light is concentrated effectively, and the performance of the light-receiving element 3 is enhanced considerably.

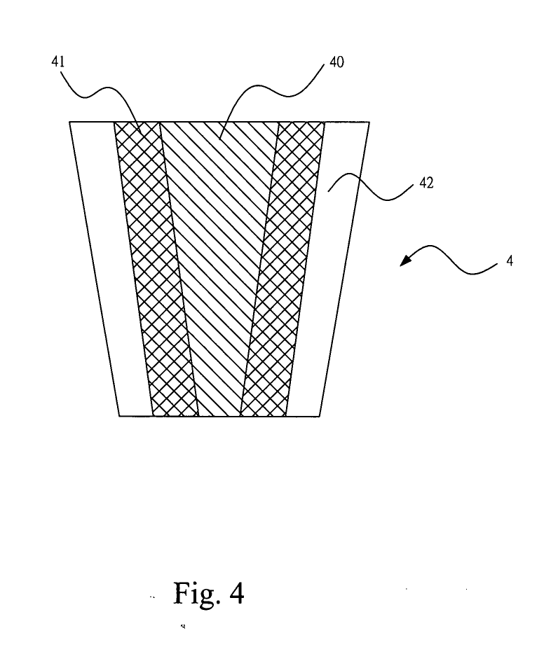

Referring to FIG. 4, a light-collection apparatus 4 includes a core 40, a first layer 41 and a second layer 42 according to a second embodiment of the present invention. The core 40 is a tapered frustum made of a light-weighted transparent material such as polymethylmethacrylate, acrylic, glass, plastic and quartz. The first layer 41 is provided on and around the core 40. The first layer 41 is made of a light-weight transparent material such as polymethylmethacrylate, acrylic, glass, plastic and quartz. The second layer 42 is provided on and around the first layer 41. The second layer 42 is made of a metallic adhesive material with a high reflectivity. The metallic adhesive material may be silver glue for example. The light-collection apparatus 4 is also excellent in collecting light, easily mass-produced at a low cost, durable and environmentally friendly.

Conclusively, the light-collection apparatus according to the present invention overcomes the drawbacks of the prior art. The light-collection apparatus is excellent in collecting light, easily mass-produced at a low cost, durable and environmentally friendly.

The present invention has been described via the detailed illustration of the embodiments. Those skilled in the art can derive variations from the embodiments without departing from the scope of the present invention. Therefore, the embodiment shall not limit the scope of the present invention defined in the claims.

1. A light-collection apparatus comprising:
a core made in the form of a frustum and used as a solid light-passing zone;
a first layer provided on the core; and
a second layer provided on the first layer.

2. The light-collection apparatus according to claim 1 wherein the core is made of a light-weighted transparent material.

3. The light-collection apparatus according to claim 2 wherein the light-weighted transparent material is polymethylmethacrylate.

4. The light-collection apparatus according to claim 2 wherein the light-weighted transparent material is acrylic.

5. The light-collection apparatus according to claim 2 wherein the light-weighted transparent material is glass.

6. The light-collection apparatus according to claim 2 wherein the light-weighted transparent material is plastic.

7. The light-collection apparatus according to claim 2 wherein the light-weighted transparent material is quartz.

8. The light-collection apparatus according to claim 1 wherein the first layer is made of a metallic adhesive material with a high reflectivity.

9. The light-collection apparatus according to claim 8 wherein the metallic adhesive material is silver glue.

10. The light-collection apparatus according to claim 1 wherein the first layer is made of a light-weighted transparent material.

11. The light-collection apparatus according to claim 10 wherein the light-weighted transparent material is polymethylmethacrylate.

12. The light-collection apparatus according to claim 10 wherein the light-weighted transparent material is acrylic.

13. The light-collection apparatus according to claim 10 wherein the light-weighted transparent material is glass.

14. The light-collection apparatus according to claim 10 wherein the light-weighted transparent material is plastic.

15. The light-collection apparatus according to claim 10 wherein the light-weighted transparent material is quartz.

16. The light-collection apparatus according to claim 1 wherein the second layer is made of a light-weighted transparent material.

17. The light-collection apparatus according to claim 16 wherein the light-weighted transparent material is polymethylmethacrylate.

18. The light-collection apparatus according to claim 16 wherein the light-weighted transparent material is acrylic.

19. The light-collection apparatus according to claim 16 wherein the light-weighted transparent material is glass.

20. The light-collection apparatus according to claim 16 wherein the light-weighted transparent material is plastic.
